(19) United States
(12) Patent Application Publication
(10) Pub. No.: US 2026/0095515 A1
(43) Pub. Date: Apr. 2, 2026

(54) SINGLE-WIRE PROTOCOL METHOD

(71) Applicant: Global Mixed-mode Technology Inc., Hsin-Chu (TW)

(72) Inventor: Chen-Yu Liao, Nantou County (TW)

(73) Assignee: Global Mixed-mode Technology Inc., Hsin-Chu (TW)

(21) Appl. No.: 18/902,786

(22) Filed: Sep. 30, 2024

(51) Int. Cl. H04L 69/08; G06F 13/42; H04L 12/40

(52) U.S. Cl. CPC H04L 69/08; G06F 13/4282; H04L 12/40006

(57) ABSTRACT

A single-wire protocol method comprises: inputting (X1+M1) pulses through a single-wire bus according to a pulse definition table, where M1 is less than or equal to 2^{A1}; and after inputting the (X1+M1) pulses, inputting (Y1+N1) pulses through the single-wire bus according to the pulse definition table, where N1 is less than or equal to 2^{B1}, the (M1+N1) pulses are utilized to set a first output voltage, and the first output voltage has at most (2^{A1}×2^{B1}) voltage levels based on A1 and B1. By dividing the first output voltage into two parts, it is capable of reducing a write time of a voltage setting instruction.

### BACKGROUND OF THE INVENTION

### 1. Field of the Invention

The present invention relates to a single-wire protocol method, and more particularly, to a single-wire protocol method which is capable of reducing a write time of a parameter setting instruction.

### 2. Description of the Prior Art

Different from I2C (Inter-Integrated Circuit), PCI (Peripheral Component Interconnect), ISA (Industrial Standard Architect), or LPC (Low Pin Count) communication protocol, a single-wire protocol technology transmits parameter data or a control method simply by one signal/bus. The advantage is that it is capable of reducing the pin counts greatly while the disadvantage is that the transmission speed is too slow. In general, the single-wire protocol technology may be utilized to adjust an output voltage. For example, when each voltage step is 25 mV and there are 512 steps, if a conventional single-wire protocol technology is adopted, it may at most take about 512 pulse periods to set the output voltage once. When the system needs to change the output voltage many times, the total write time may take too long.

Thus, a new single-wire protocol technology is needed to reduce a write time of a parameter setting instruction.

### SUMMARY OF THE INVENTION

According to the present invention, a single-wire protocol method which is capable of reducing a write time of a parameter setting instruction is provided. When the single-wire protocol method is applied to a voltage setting instruction, the single-wire protocol method may comprise: Inputting (X1+M1) pulses through a single-wire bus SWB according to a pulse definition table 200, where X1 is greater than or equal to 0, M1 is greater than or equal to 1, M1 is less than or equal to 2^{A1}, and A1 is greater than or equal to 1. After inputting the (X1+M1) pulses, inputting (Y1+N1) pulses through the single-wire bus SWB according to the pulse definition table 200, where Y1 is greater than or equal to 0, N1 is greater than or equal to 1, N1 is less than or equal to 2^{B1}, B1 is greater than or equal to 1, the (M1+N1) pulses are utilized to set a first output voltage, and the first output voltage has at most (2^{A1}×2^{B1}) voltage levels based on A1 and B1. By dividing the first output voltage into two parts, it is capable of reducing a write time of a voltage setting instruction. Moreover, a single-wire signal SWS may be transmitted to a power supply circuit through the single-wire bus SWB, and the power supply circuit is utilized to supply the first output voltage.

After inputting the (X1+M1) pulses, the first output voltage is not written out. After inputting the (Y1+N1) pulses, the first output voltage is written out. By doing so, it is capable of avoiding that the first output voltage is temporarily changed to a wrong voltage.

The single-wire signal SWS is applied to the single-wire bus SWB. When the single-wire signal SWS is changed from a low level to a high level, if a duration time of the high level is greater than a turn-on time, the single-wire bus SWB is enabled. When the single-wire signal SWS is changed from the high level to the low level, if a duration time of the low level is greater than a turn-off time, the single-wire bus SWB is disabled. A low-level duration time of each pulse is between a first predetermined time and a second predetermined time. A high-level duration time of each pulse is between a third predetermined time and a fourth predetermined time. After inputting the (X1+M1) pulses, if a high-level maintenance time of the single-wire signal SWS is between a fifth predetermined time and a sixth predetermined time, the number of pulses (X1+M1) is stored. After inputting the (Y1+N1) pulses, if a high-level maintenance time of the single-wire signal SWS is between the fifth predetermined time and the sixth predetermined time, the number of pulses (Y1+N1) is stored.

Broadly speaking, the designer may substitute a parameter for the output voltage and then the parameter is divided into two parts, thereby reducing the write time of the parameter setting instruction. In other words, the single-wire protocol method may comprise: Inputting (X2+M2) pulses through a single-wire bus SWB1 according to a pulse definition table 201, where X2 is greater than or equal to 0, M2 is greater than or equal to 1, M2 is less than or equal to 2^{A2}, and A2 is greater than or equal to 1. After inputting the (X2+M2) pulses, inputting (Y2+N2) pulses through the single-wire bus SWB1 according to the pulse definition table 201, where Y2 is greater than or equal to 0, N2 is greater than or equal to 1, N2 is less than or equal to 2^{B2}, B2 is greater than or equal to 1, the (M2+N2) pulses are utilized to set a parameter PARA, and the parameter PARA has at most (2^{A2}×2^{B2}) values based on A2 and B2.

The single-wire signal SWS1 is applied to the single-wire bus SWB1. When the single-wire signal SWS1 is changed from a low level to a high level, if a duration time of the high level is greater than the turn-on time, the single-wire bus SWB1 is enabled. When the single-wire signal SWS1 is changed from the high level to the low level, if a duration time of the low level is greater than the turn-off time, the single-wire bus SWB1 is disabled. A low-level duration time of each pulse is between the first predetermined time and the second predetermined time. A high-level duration time of each pulse is between the third predetermined time and the fourth predetermined time. After inputting the (X2+M2) pulses, if a high-level maintenance time of the single-wire signal SWS1 is between the fifth predetermined time and the sixth predetermined time, the number of pulses (X2+M2) is stored. After inputting the (Y2+N2) pulses, if a high-level maintenance time of the single-wire signal is between the fifth predetermined time and the sixth predetermined time, the number of pulses (Y2+N2) is stored.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

The above-mentioned and other objects, features, and advantages of the present invention will become apparent with reference to the following descriptions and accompanying drawings, wherein:

FIG. 1 is a schematic diagram showing a power supply circuit according to one embodiment of the present invention;

FIG. 2 is a pulse definition table according to one embodiment of the present invention;

FIG. 3 is a timing chart according to one embodiment of the present invention;

FIG. 4 is a first flow chart according to one embodiment of the present invention; and

FIG. 5 is a second flow chart according to one embodiment of the present invention.

### DETAILED DESCRIPTION

Preferred embodiments according to the present invention will be described in detail with reference to the drawings.

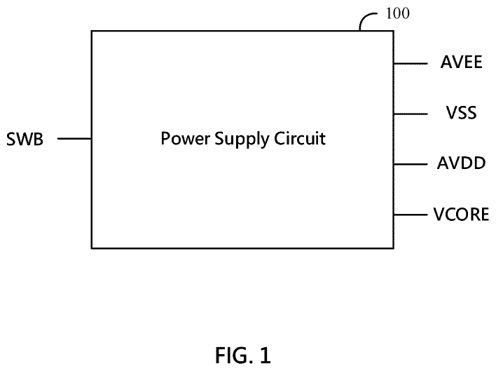

FIG. 1 is a schematic diagram showing a power supply circuit 100 according to one embodiment of the present invention, where the power supply circuit 100 adopts a single-wire protocol to communicate with a system. For instance, the power supply circuit 100 may be an integrated power supply circuit. The power supply circuit 100 may output a first output voltage AVEE, a second output voltage VSS, a third output voltage AVDD, and a fourth output voltage VCORE based on a single-wire bus SWB. The first output voltage may be a negative voltage. Each of the second output voltage VSS, the third output voltage AVDD, and the fourth output voltage VCORE may be a positive voltage.

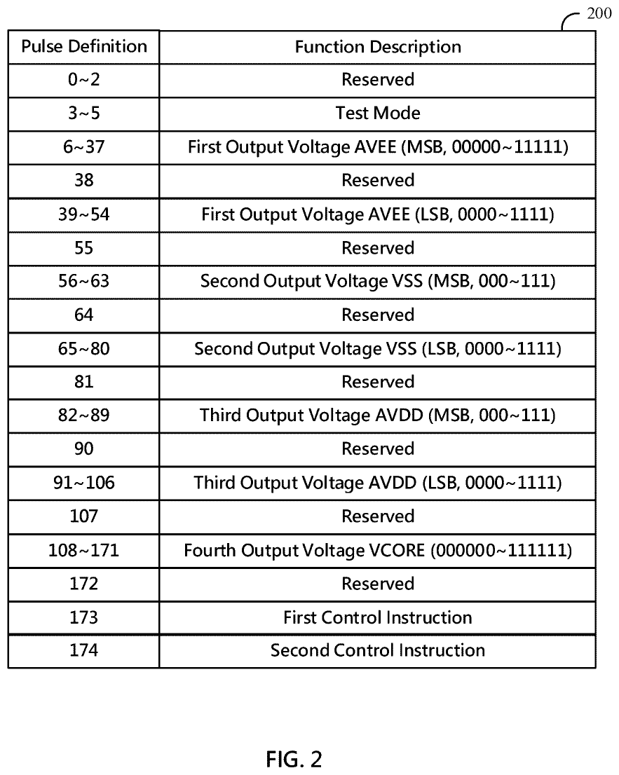

FIG. 2 is a pulse definition table 200 according to one embodiment of the present invention, where the first column represents a pulse definition and the second column represents a function description corresponding to the pulse definition. The system may transmit a single-wire signal SWS to the power supply circuit 100 through the single-wire bus SWB, where the single-wire signal SWS may comprise a plurality of pulses and the power supply circuit 100 is utilized to supply the first output voltage AVEE. For instance, according to the pulse definition table 200, when the number of pulses is between 3 and 5, the power supply circuit 100 may enter a test mode. When the number of pulses is between 6 and 37, the power supply circuit 100 may be utilized to set the most significant bits (MSB) of the first output voltage AVEE, where the most significant bits of the first output voltage AVEE may be between 00000 and 11111. When the number of pulses is between 39 and 54, the power supply circuit 100 may be utilized to set the least significant bits (LSB) of the first output voltage AVEE, where the least significant bits of the first output voltage AVEE may be between 0000 and 1111. When the number of pulses is between 56 and 63, the power supply circuit 100 may be utilized to set the most significant bits of the second output voltage VSS, where the most significant bits of the second output voltage VSS may be between 000 and 111. When the number of pulses is between 65 and 80, the power supply circuit 100 may be utilized to set the least significant bits of the second output voltage VSS, where the least significant bits of the second output voltage VSS may be between 0000 and 1111. When the number of pulses is between 82 and 89, the power supply circuit 100 may be utilized to set the most significant bits of the third output voltage AVDD, where the most significant bits of the third output voltage AVDD may be between 000 and 111. When the number of pulses is between 91 and 106, the power supply circuit 100 may be utilized to set the least significant bits of the third output voltage AVDD, where the least significant bits of the third output voltage AVDD may be between 0000 and 1111. When the number of pulses is 173, the power supply circuit 100 may be utilized to execute a first control instruction. When the number of pulses is 174, the power supply circuit 100 may be utilized to execute a second control instruction.

According to one embodiment of the present invention, the system may input 6 to 37 pulses for setting the most significant bits (i.e., 5 bits) of the first output voltage AVEE through the single-wire bus SWB. After inputting 6 to 37 pulses, the system may input 39 to 54 pulses for setting the least significant bits (i.e., 4 bits) of the first output voltage AVEE through the single-wire bus SWB. By doing so, it is capable of forming the complete first output voltage AVEE, where the first output voltage AVEE has at most (2⁵×2⁴) (i.e., 512) voltage levels, and it may take at most about (37+54) pulse periods to set the first output voltage AVEE once. However, when adopting the conventional single-wire protocol technology, it may take at most about 512 pulse periods to set an output voltage once. In other words, when adopting the conventional single-wire protocol technology, it may take about 5 milliseconds to set the output voltage once. When adopting the single-wire protocol technology of the present invention by dividing the output voltage into two parts, it may only take about 1 millisecond to set the output voltage once for the same voltage instruction, thereby reducing a write time of a voltage setting instruction. Furthermore, when adopting the single-wire protocol technology of the present invention, the output voltage may be divided into three parts or three parts above, and the detailed description is omitted in the present invention.

If the voltage change is large, after inputting 6 to 37 pulses, the first output voltage AVEE is not written out, thereby avoiding that the first output voltage AVEE is temporarily changed to a wrong voltage. After inputting 39 to 54 pulses, the first output voltage AVEE is written out. If the voltage change is small, it is capable of changing the first output voltage AVEE in a fast way after inputting 39 to 54 pulses. It is noted that the above feature is not a must-be feature in the present invention. The designer may adopt the other method to avoid that the first output voltage AVEE is temporarily changed to a wrong voltage.

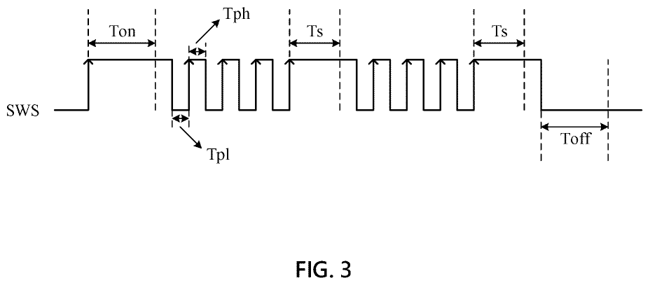

FIG. 3 is a timing chart according to one embodiment of the present invention, where the single-wire signal SWS is applied to the single-wire bus SWB. When the single-wire signal SWS is changed from a low level to a high level, if a duration time of the high level is greater than a turn-on time Ton, the single-wire bus SWB may be enabled and a power-on action may be executed. When the single-wire signal SWS is changed from the high level to the low level, if a duration time of the low level is greater than a turn-off time Toff, the single-wire bus SWB may be disabled and a power-off action may be executed. Moreover, a low-level duration time Tpl of each pulse may be between a first predetermined time and a second predetermined time. A high-level duration time Tph of each pulse may be between a third predetermined time and a fourth predetermined time. After inputting pulse(s), if a high-level maintenance time Ts of the single-wire signal SWS is between a fifth predetermined time and a sixth predetermined time, the number of the pulse(s) may be stored.

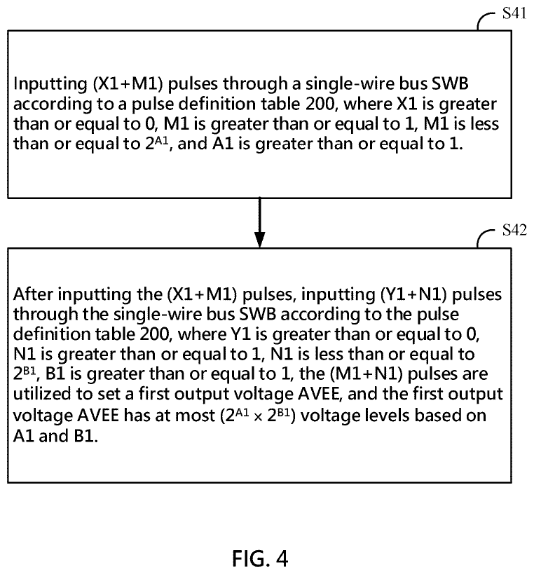

FIG. 4 is a first flow chart according to one embodiment of the present invention. The first flow chart is as follows: Inputting (X1+M1) pulses through a single-wire bus SWB according to a pulse definition table 200, where X1 is greater than or equal to 0, M1 is greater than or equal to 1, M1 is less than or equal to 2^{A1}, and A1 is greater than or equal to 1 (Step S41). After inputting the (X1+M1) pulses, inputting (Y1+N1) pulses through the single-wire bus SWB according to the pulse definition table 200, where Y1 is greater than or equal to 0, N1 is greater than or equal to 1, N1 is less than or equal to 2^{B1}, B1 is greater than or equal to 1, the (M1+N1) pulses are utilized to set a first output voltage AVEE, and the first output voltage AVEE has at most (2^{A1}×2^{B1}) voltage levels based on A1 and B1 (Step S42). According to the pulse definition table 200 of FIG. 2, X1 is equal to 5, Y1 is equal to 38, A1 is equal to 5, and B1 is equal to 4. In addition, the single-wire protocol method of the present invention may be utilized to set the second output voltage VSS or the third output voltage AVDD, the detailed description is omitted in the present invention. In other words, after inputting the (Y1+N1) pulses, the second output voltage VSS and the third output voltage AVDD may be set.

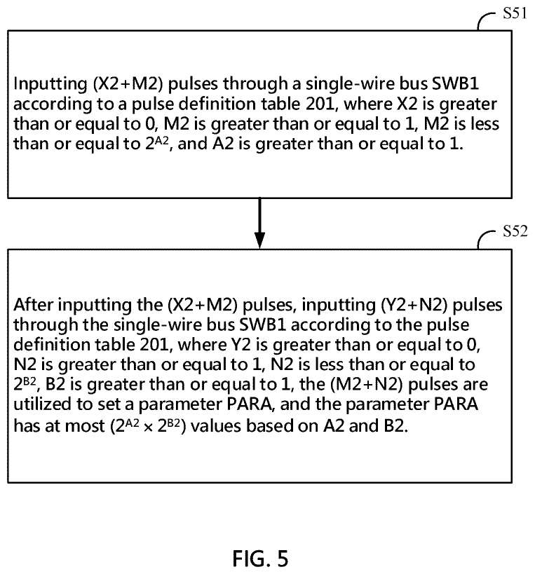

Broadly speaking, the designer may substitute a parameter for the output voltage and then the parameter is divided into two parts. FIG. 5 is a second flow chart according to one embodiment of the present invention. The second flow chart is as follows: Inputting (X2+M2) pulses through a single-wire bus SWB1 according to a pulse definition table 201, where X2 is greater than or equal to 0, M2 is greater than or equal to 1, M2 is less than or equal to 2^{A2}, and A2 is greater than or equal to 1 (Step S51). After inputting the (X2+M2) pulses, inputting (Y2+N2) pulses through the single-wire bus SWB1 according to the pulse definition table 201, where Y2 is greater than or equal to 0, N2 is greater than or equal to 1, N2 is less than or equal to 2^{B2}, B2 is greater than or equal to 1, the (M2+N2) pulses are utilized to set a parameter PARA, and the parameter PARA has at most (2^{A2}×2^{B2}) values based on A2 and B2 (Step S52). Similarly, after inputting the (X2+M2) pulses, the parameter PARA is not written out. After inputting the (Y2+N2) pulses, the parameter PARA is written out. The pulse definition table 201 may be similar to the pulse definition table 200. For example, the pulse definition table 201 may substitute the parameter for the output voltage. Furthermore, the timing chart of FIG. 3 may be applied to the parameter, too. That is, the single-wire protocol technology of the present invention may be utilized to reduce a write time of a parameter setting instruction. The parameter PARA may be the first output voltage AVEE, the second output voltage VSS, the third output voltage AVDD, a current limit, or the other parameter. Thus, the single-wire protocol technology of the present invention may be applied to the power supply circuit 100 and the other technology field.

According to one embodiment of the present invention, the single-wire protocol method of the present invention may be applied to a power supply circuit, a power management integrated circuit, an organic light-emitting diode, a liquid crystal display, augmented reality glasses, or virtual reality glasses. The single-wire protocol method of the present invention may be utilized to reduce the write time of the voltage setting instruction or the write time of the parameter setting instruction.

While the present invention has been described by the preferred embodiments, it is to be understood that the invention is not limited to the disclosed embodiments. On the contrary, it is intended to cover various modifications. Therefore, the scope of the appended claims should be accorded the broadest interpretation so as to encompass all such modifications.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A single-wire protocol method comprising:
inputting (X1+M1) pulses through a single-wire bus according to a pulse definition table, wherein X1 is greater than or equal to 0, M1 is greater than or equal to 1, M1 is less than or equal to 2^{A1}, and A1 is greater than or equal to 1; and
after inputting the (X1+M1) pulses, inputting (Y1+N1) pulses through the single-wire bus according to the pulse definition table, wherein Y1 is greater than or equal to 0, N1 is greater than or equal to 1, N1 is less than or equal to 2^{B1}, B1 is greater than or equal to 1, the (M1+N1) pulses are utilized to set a first output voltage, and the first output voltage has at most (2^{A1}×2^{B1}) voltage levels based on A1 and B1.

2. The single-wire protocol method of claim 1, wherein the first output voltage is a negative voltage.

3. The single-wire protocol method of claim 1, wherein a single-wire signal is transmitted to a power supply circuit through the single-wire bus, and the power supply circuit is utilized to supply the first output voltage.

4. The single-wire protocol method of claim 1, wherein after inputting the (X1+M1) pulses, the first output voltage is not written out.

5. The single-wire protocol method of claim 1, wherein after inputting the (Y1+N1) pulses, the first output voltage is written out.

6. The single-wire protocol method of claim 1, wherein a single-wire signal is applied to the single-wire bus, and when the single-wire signal is changed from a low level to a high level, if a duration time of the high level is greater than a turn-on time, the single-wire bus is enabled and a power-on action is executed.

7. The single-wire protocol method of claim 1, wherein a single-wire signal is applied to the single-wire bus, and when the single-wire signal is changed from a high level to a low level, if a duration time of the low level is greater than a turn-off time, the single-wire bus is disabled and a power-off action is executed.

8. The single-wire protocol method of claim 1, wherein a low-level duration time of each pulse is between a first predetermined time and a second predetermined time.

9. The single-wire protocol method of claim 1, wherein a high-level duration time of each pulse is between a third predetermined time and a fourth predetermined time.

10. The single-wire protocol method of claim 1, wherein a single-wire signal is applied to the single-wire bus, and after inputting the (X1+M1) pulses, if a high-level maintenance time of the single-wire signal is between a fifth predetermined time and a sixth predetermined time, the number of pulses (X1+M1) is stored.

11. The single-wire protocol method of claim 1, wherein a single-wire signal is applied to the single-wire bus, and after inputting the (Y1+N1) pulses, if a high-level maintenance time of the single-wire signal is between a fifth predetermined time and a sixth predetermined time, the number of pulses (Y1+N1) is stored.

12. The single-wire protocol method of claim 1, wherein after inputting the (Y1+N1) pulses, a second output voltage VSS and a third output voltage are set.

13. The single-wire protocol method of claim 1, wherein the single-wire protocol method is applied to a power management integrated circuit.

14. The single-wire protocol method of claim 1, wherein the single-wire protocol method is applied to an organic light-emitting diode.

15. The single-wire protocol method of claim 1, wherein the single-wire protocol method is applied to a liquid crystal display.

16. The single-wire protocol method of claim 1, wherein the single-wire protocol method is applied to augmented reality glasses.

17. The single-wire protocol method of claim 1, wherein the single-wire protocol method is applied to virtual reality glasses.

18. The single-wire protocol method of claim 1, wherein the single-wire protocol method is utilized to reduce a write time of a voltage setting instruction.

19. A single-wire protocol method comprising:
inputting (X2+M2) pulses through a single-wire bus according to a pulse definition table, wherein X2 is greater than or equal to 0, M2 is greater than or equal to 1, M2 is less than or equal to 2^{A2}, and A2 is greater than or equal to 1; and
after inputting the (X2+M2) pulses, inputting (Y2+N2) pulses through the single-wire bus according to the pulse definition table, wherein Y2 is greater than or equal to 0, N2 is greater than or equal to 1, N2 is less than or equal to 2^{B2}, B2 is greater than or equal to 1, the (M2+N2) pulses are utilized to set a parameter, and the parameter has at most (2^{A2}×2^{B2}) values based on A2 and B2.

20. The single-wire protocol method of claim 19, wherein the parameter is a first output voltage, a second output voltage, or a third output voltage.

21. The single-wire protocol method of claim 19, wherein after inputting the (X2+M2) pulses, the parameter is not written out.

22. The single-wire protocol method of claim 19, wherein after inputting the (Y2+N2) pulses, the parameter is written out.

23. The single-wire protocol method of claim 19, wherein a single-wire signal is applied to the single-wire bus, and when the single-wire signal is changed from a low level to a high level, if a duration time of the high level is greater than a turn-on time, the single-wire bus is enabled.

24. The single-wire protocol method of claim 19, wherein a single-wire signal is applied to the single-wire bus, and when the single-wire signal is changed from a high level to a low level, if a duration time of the low level is greater than a turn-off time, the single-wire bus is disabled.

25. The single-wire protocol method of claim 19, wherein a low-level duration time of each pulse is between a first predetermined time and a second predetermined time.

26. The single-wire protocol method of claim 19, wherein a high-level duration time of each pulse is between a third predetermined time and a fourth predetermined time.

27. The single-wire protocol method of claim 19, wherein a single-wire signal is applied to the single-wire bus, and after inputting the (X2+M2) pulses, if a high-level maintenance time of the single-wire signal is between a fifth predetermined time and a sixth predetermined time, the number of pulses (X2+M2) is stored.

28. The single-wire protocol method of claim 19, wherein a single-wire signal is applied to the single-wire bus, and after inputting the (Y2+N2) pulses, if a high-level maintenance time of the single-wire signal is between a fifth predetermined time and a sixth predetermined time, the number of pulses (Y2+N2) is stored.

29. The single-wire protocol method of claim 19, wherein the single-wire protocol method is applied to a power management integrated circuit.

30. The single-wire protocol method of claim 19, wherein the single-wire protocol method is applied to an organic light-emitting diode.

31. The single-wire protocol method of claim 19, wherein the single-wire protocol method is applied to a liquid crystal display.

32. The single-wire protocol method of claim 19, wherein the single-wire protocol method is applied to augmented reality glasses.

33. The single-wire protocol method of claim 19, wherein the single-wire protocol method is applied to virtual reality glasses.

34. The single-wire protocol method of claim 19, wherein the single-wire protocol method is utilized to reduce a write time of a parameter setting instruction.
